(19) United States
(12) Patent Application Publication
(10) Pub. No.: US 2014/0235129 A1
(43) Pub. Date: Aug. 21, 2014

(54) NANOWEB STRUCTURE

(71) Applicant: E I DU PONT DE NEMOURS AND COMPANY, Wilmington, DE (US)

(72) Inventors: Tao Huang, Downingtown, PA (US); Joseph Robert Guckert, Chester, VA (US)

(73) Assignee: E I DU PONT DE NEMOURS AND COMPANY, Wilmington, DE (US)

(21) Appl. No.: 14/185,019

(22) Filed: Feb. 20, 2014

Related U.S. Application Data
(60) Provisional application No. 61/849,827, filed on Feb. 20, 2013.

(51) Int. Cl. B32B 5/02

(52) U.S. Cl. CPC B32B 5/022
USPC 442/335; 442/401; 442/327

(57) ABSTRACT

A nanoweb of polymeric nanofibers in which all of the polymeric fibers have a mean curl index when measured over any 100 micron long segment of less than 0.10 and the nanoweb has a uniformity index of less than 5.0. The nanoweb may have a fiber orientation index of between 0.8 and 1.2 or a mean flow pore size minus the mode of the pore size is less than 1.0 and simultaneously the ratio of the 99% width of the pore size distribution (W) to the width at half height of the pore size distribution (H_{M0}) is less than 10.0. The invention is further directed to a nanoweb with a multiplicity of continuous polymeric fibers arranged in clusters wherein fibers have an average diameter less than 1,000 nm and wherein the web has a gross morphology corresponding to the following structure; each fiber is laid in an arc of essentially constant curvature along its length; all of the fiber arcs in a given cluster have essentially the same curvature; the fiber arcs in a given cluster are co-planar and any given fiber arc in a given cluster lies spaced away from and essentially parallel to the other arcs in said cluster in the plane of the cluster; and the centers of curvature of the fiber arcs in a given cluster are co-linear.

### FIELD OF THE INVENTION

This invention relates to nanoweb products with uniquely uniform structure. In particular, the nanowebs are useful for selective barrier end uses such as in the fields of air and liquid filtration and battery and capacitor separators.

### BACKGROUND

Polymeric nanofibers can be produced from solution processes such as electrospinning or electroblowing. In order, however, to obtain commercially viable throughputs from nanofiber manufacturing processes, a melt spinning process is required. Conventional melt blowing processes that randomly lay down fibers do not provide sufficient uniformity at sufficiently high throughputs for most end use applications. Random, uncontrolled, laydown also in practice does not provide an isotropic web as might be expected. What is needed is an isotropic web of nanofibers of high uniformity.

### SUMMARY OF THE INVENTION

The present invention is directed to a nanoweb comprising nanofibers. In one embodiment, the fibers are produced by a melt spinning process. In a further embodiment, the fibers comprise a polyolefin. In a further embodiment, the nanoweb comprises fibers in which all of the fibers comprise a polyolefin. At least some of the fibers consist essentially of a polyolefin or all of the fibers consist essentially of a polyolefin. At least some of the fibers may consist of a polyolefin or all of the fibers may consist of a polyolefin.

The polyolefin may, without limit, be selected from the group consisting of polypropylene, polyethylene, polybutene, poly methylpentene, and copolymers thereof. The polyolefin may also be a copolymer of ethylene with one or more olefin monomers, including propene, butane, hexane or octane.

In a further embodiment the nanoweb comprises polymeric nanofibers in which the polymeric fibers have a mean curl index of less than 0.10 and the nanoweb has a uniformity index of less than 5.0. In a further embodiment the nanoweb has a fiber orientation index of between 0.8 and 1.2.

The nanoweb of the invention may also have a mean flow pore size minus the mode of the pore size of less than 1.0. In a further embodiment, the ratio of the 99% width of the pore size distribution (W) to the peak height of the pore size at the mode M0 is less than 0.1.

In a still further embodiment the nanoweb of the invention may comprise a multiplicity of continuous polymeric fibers arranged in clusters wherein fibers have an average diameter less than 1,000 nm and wherein the web has a gross morphology corresponding to the following structure;
(i) each fiber is laid in an arc of essentially constant curvature along its length;
(ii) all of the fiber arcs in a given cluster have essentially the same curvature;
(iii) the fiber arcs in a given cluster are co-planar and any given fiber arc in a given cluster lies spaced away from and essentially parallel to the other arcs in said cluster in the plane of the cluster; and
(iv) the centers of curvature of the fiber arcs in a given cluster are co-linear.

### BRIEF DESCRIPTION OF THE FIGURES

FIG. 1 is a schematic diagram illustrating an embodiment of an as spun nanoweb pattern formed overlaying of fibers from a multiple centrifugal spin heads of the invention.

FIG. 2 is a schematic illustration of fiber laydown pattern from 5 centrifugal spin heads.

FIG. 3 is a schematic illustration the fiber laydown pattern from 10 centrifugal spin heads.

FIG. 4 is an illustration the fiber laydown pattern and web formation from 3 centrifugal spin heads.

FIG. 5 is an illustration used in the web uniformity calculation in the present invention.

FIGS. 6A-D are illustrations of the characterization and measurement method on fiber orientation used in the present invention.

FIG. 7 is an illustration of the characterization and measurement method on the fiber Curl Index (the fiber straightness) used in the present invention.

FIG. 8 is an illustration of the characterization and measurement method on the web pore size used in the present invention.

FIGS. 9A-C show web and scanning electron micrograph (SEM) images of a centrifugal melt-spun polypropylene nanoweb of Example 1.

FIGS. 10A-C show web and SEM images of a centrifugal melt-spun polypropylene nanoweb of Example 2.

FIGS. 11A-C show web and SEM images of a centrifugal melt-spun polypropylene nanoweb of Example 3.

FIGS. 12A-C show web and SEM images of a centrifugal melt-spun polyethylene terephthalate nanoweb of Example 4.

FIGS. 13A-C show web and SEM images of a centrifugal melt-spun polypropylene nanoweb of Comparative Example 1.

FIGS. 14A-C show web and SEM images of a melt blown polypropylene web of Comparative Example 3.

FIGS. 15A-C show web and SEM images of a melt blown polypropylene web of Comparative Example 4.

FIGS. 16A-C show web and SEM images of a melt blown polypropylene web of Comparative Example 5.

FIGS. 17A-C show web and SEM images of a melt blown polypropylene web of Comparative Example 6.

FIGS. 18A-H show SEM images used to prepare orientation plots.

FIGS. 18A-B are an SEM image and orientation plot of centrifugal melt-spun polypropylene nanoweb of Example 1. FIGS. 18C-D are an SEM image and orientation plot of melt blown polypropylene web of Comparative Example 3. FIGS. 18E-F are an SEM image and orientation plot of a melt blown polypropylene web of Comparative Example 4. FIGS. 18G-H are an SEM image and orientation plot of a melt blown polypropylene web of Comparative Example 5.

FIG. 19 shows stress-strain curves (normalized by basis weight) of centrifugal spun polypropylene webs compared to melt blown polypropylene webs.

FIG. 20 shows stress-strain curves (normalized by basis weight) of centrifugal spun polypropylene webs in the machine direction (MD) and the transverse direction (TD).

FIGS. 21A-B show the pore size distribution of centrifugal spun polypropylene nanowebs of Examples 1 and 2.

FIGS. 22A-B show the pore size distribution of melt blown webs of Comparative Examples 3 and 4.

FIGS. 23A-B shows the pore size distribution of melt blown webs of Comparative Example 5 and 6.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The word “comprising” as used herein is taken to include in its scope the meanings of the terms “consisting of” and “consisting essentially of.”

### DEFINITIONS

The term “nonwoven” means here a web including a multitude of essentially randomly oriented fibers where no overall repeating structure can be discerned by the naked eye in the arrangement of fibers. The fibers can be bonded to each other, or can be unbonded and entangled to impart strength and integrity to the web. The fibers can be staple fibers or continuous fibers, and can comprise a single material or a multitude of materials, either as a combination of different fibers or as a combination of similar fibers each comprising of different materials.

The term “nanoweb” as applied to the present invention is synonymous with “nano-fiber web” or “nanofiber web” and refers to a web constructed predominantly of nanofibers. The nanoweb may be a nonwoven, or it may be a more ordered structure. “Predominantly” means that greater than 50% of the fibers in the web are nanofibers, where the term “nanofibers” as used herein refers to fibers having a number average diameter less than 1000 nm, even less than 800 nm, even between about 50 nm and 500 nm, and even between about 100 and 400 nm. In the case of non-round cross-sectional nanofibers, the term “diameter” as used herein refers to the greatest cross-sectional dimension. The nanoweb of the invention can also have greater than 70%, or 90% or it can even contain 100% of nanofibers.

By “melt spinning process” is meant a fiber forming process that produces fibers from a material that has been fluidized by heat. The use of plasticizers to lower the temperature at which fluidization occurs is possible in a melt spinning process. Melt spinning is to be differentiated from solution spinning in which a material is dissolved in a solvent before spinning, generally to a level of 50% or less material by weight of material in solution.

By “centrifugal spinning process” is meant any process in which fibers are formed by ejection of a fiberizable material such as a polymer melt or solution from a rotating member. As used herein, the term may also include conventional spinning processes in which a fibrous stream is ejected from a die and is caused to travel in a circular or spiral pattern towards a receiver.

By “melt blowing process” is meant a process that produces fibers by pushing a polymer melt through an orifice and then attenuating the fibers by means of an air flow directed generally in the direction of the fibers. The melt blowing process is exemplified in U.S. Pat. No. 3,849,241 or U.S. Pat. No. 4,380,570.

By “rotating member” is meant a spinning device that propels or distributes a material from which fibrils or fibers are formed by centrifugal force, whether or not another means such as air or electrostatic force is used to aid in such propulsion.

By “fibril” is meant the elongated structure that may be formed as a precursor to fine fibers that form when the fibrils are attenuated. Fibrils are formed at a discharge point of the rotating member. The discharge point may be an edge, as described for example in U.S. Pat. No. 8,277,711, or an orifice through which fluid is extruded to form fibers.

By “essentially” is meant that if a parameter is held “essentially” at a certain value, then changes in the numerical value that describes the parameter away from that value that do not affect the functioning of the invention are to be considered within the scope of the description of the parameter. By “consisting essentially of” is meant that constituents other than that listed may appear in the invention if they do not change the claimed structure of the invention.

By “curvature” of a fiber is meant the inverse of the radius of curvature of a segment of the fiber.

### DESCRIPTION OF THE INVENTION

The present invention is directed to a product of as spun fibers produced as uniform fibrous webs of nanowebs for selective barrier end uses such as in the fields of air and liquid filtration and battery and capacitor separators. In one embodiment, the fibers are produced by a melt spinning process. In a further embodiment, the fibers comprise a polyolefin. In a further embodiment, the nanoweb comprises fibers in which all of the fibers comprise a polyolefin. At least some of the fibers consist essentially of a polyolefin or all of the fibers consist essentially of a polyolefin. At least some of the fibers may consist of a polyolefin or all of the fibers may consist of a polyolefin.

The polyolefin may, without limit, be selected from the group consisting of polypropylene, polyethylene, polybutene, poly methylpentene, and copolymers thereof. The polyolefin may also be a copolymer of ethylene with one or more olefin monomers, including propene, butane, hexane or octane.

In a further embodiment the nanoweb comprises polymeric nanofibers in which the polymeric fibers have a mean curl index of less than 0.10 and the nanoweb has a uniformity index of less than 5.0. In a further embodiment the nanoweb has a fiber orientation index of between 0.8 and 1.2.

The nanoweb of the invention may also have a mean flow pore size minus the mode of the pore size of less than 1.0. In a further embodiment, the ratio of the 99% width of the pore size distribution (W) to the peak height of the pore size at the mode M0 is less than 0.1.

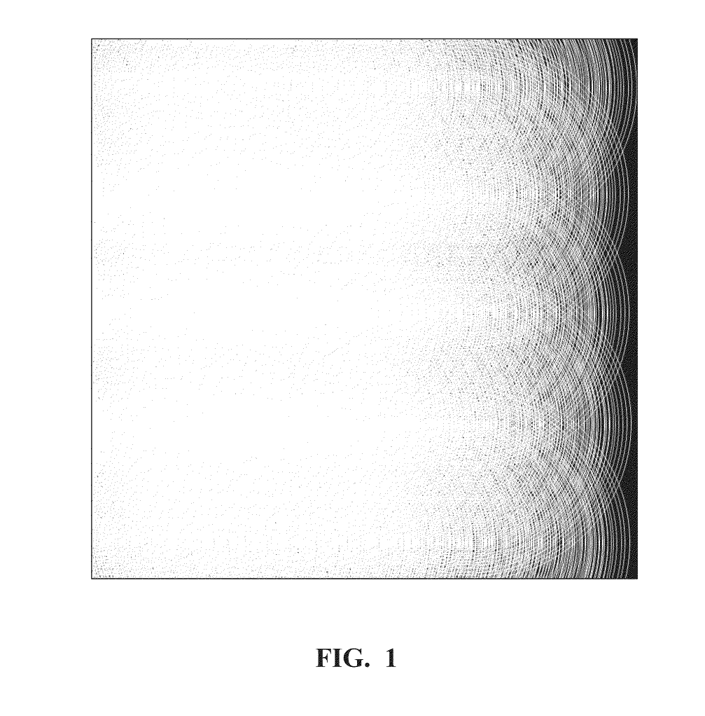

Turning now to the figures, FIG. 1 is a schematic diagram illustrating an embodiment of an as spun nanoweb pattern of the invention formed by overlaying of fibers from a multiple centrifugal spin heads.

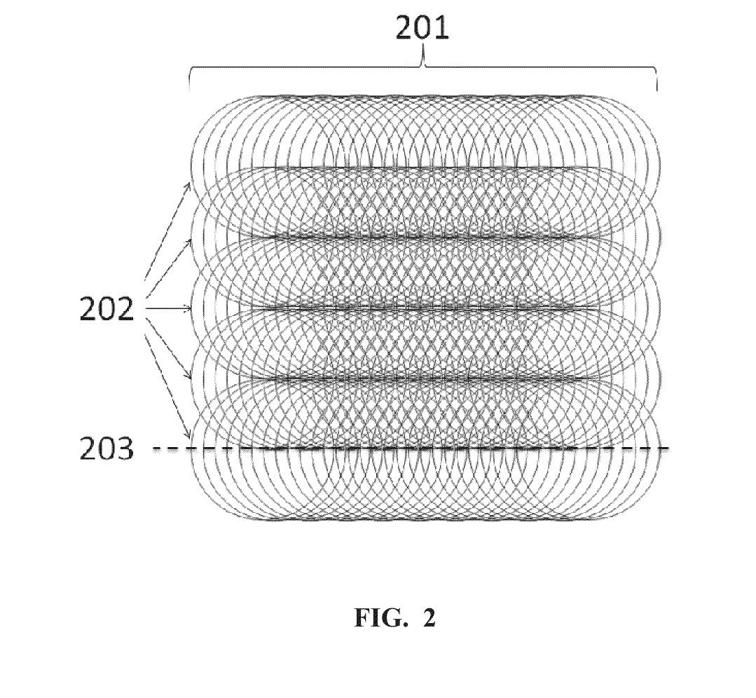

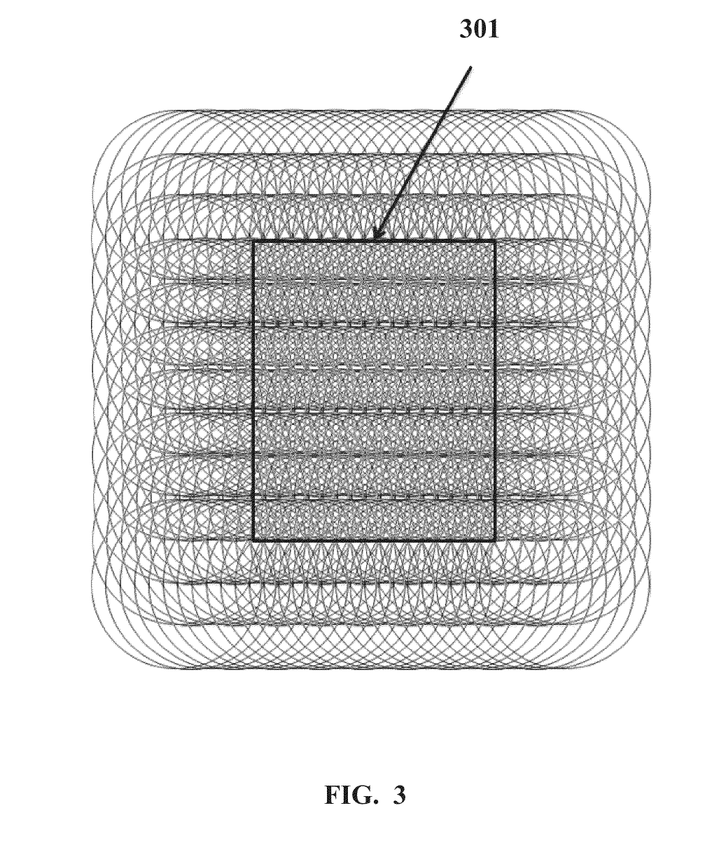

FIG. 2 is a schematic diagram of a centrifugal spun nanoweb of the invention for purposes of showing the structure of the invention. FIG. 2 is an illustration of fiber laydown pattern from a multiple centrifugal spin heads (five heads in the diagram). In FIG. 2 can be seen at the edge of the structure the fiber clusters (201) that are made up of arcs (202) all of essentially equal curvature. The centers of the arcs in a given cluster are co-linear, meaning that their centers all fall essentially on one line. Item 203 in FIG. 2 shows an example of one of the lines for that embodiment. In one embodiment of the process, the line will be the machine direction of formation of the web. FIG. 3 is an illustration of fiber laydown pattern from a multiple centrifugal spin heads (ten heads in the diagram). Item 301 in FIG. 3 shows an exemplary uniform web region with crossing fibers that is obtained by laydown of a multiplicity of clusters.

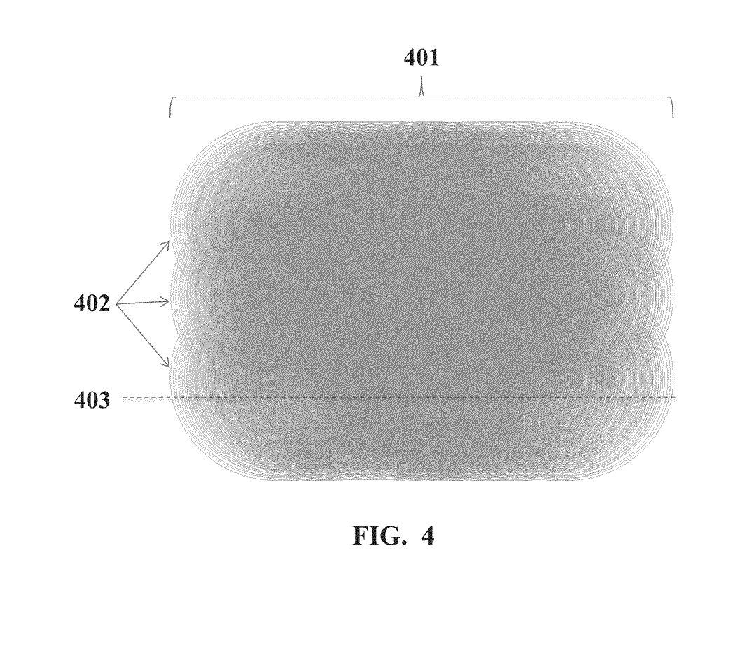

FIG. 4 is an illustration of web laydown pattern from a multiple centrifugal spin heads (for clarity, three heads used in the diagram). In FIG. 4, the fiber cloud with co-centered fiber circles can be formed from one spin head. In FIG. 4, can be seen at the edge of the structure the fiber clusters (401) that are made up of arcs (402) all of essentially equal curvature. The centers of the arcs in a given cluster are co-linear, meaning that their centers all fall essentially on one line. Item 403 in FIG. 4 shows an example of one of the lines for that embodiment. In one embodiment of the process, the line will be the machine direction of formation of the web.

In a further embodiment of the product of the invention, the web comprises structures as shown in FIG. 1 layered in a face to face relationship to form a multilayered web.

As further illustrations of the web of the invention, optical and SEM images of a centrifugal spun nanoweb obtained by the method explained below.

### EXAMPLES

The invention is directed to a web with an exceptionally high uniformity in terms of basis weight, fiber morphology, pore structure, and visual uniformity as defined herein. In a preferred embodiment, the web is a nanoweb. The possible levels of uniformity of centrifugal spun nanoweb in the invention will now be explained with reference to certain non-limiting examples.

### Scanning Electron Microscopy (SEM)

In order to reveal the fiber morphology in different levels of detail, SEM images were taken at nominal magnifications of ×25, ×100, ×250, ×500, ×1,000, ×2,500, ×5,000 and ×10,000.

### Optical Web Imaging and Measurement of Uniformity Index

A web sample was placed on a lighting box providing uniform transmitted light from a lighting plate using arrays of LED's. A digital camera was used for taking images from different sizes of samples with desired megapixel numbers. The web images in the following examples were taken and measured on a web sample size of 300 mm by 200 mm at 10.2 megapixels of 3872 by 2592 pixels.

Web uniformity can be thought of as the coefficient of web mass variation. A web visual uniformity can be correlated to the coefficient of pixel gray level variation of the web image. A web visual uniformity index (UI) is calculated by the following steps:

(i) The pixel field is first divided into a series of 2×2 pixel blocks. This division is defined as layer 1.
(ii) Referring now to FIG. 4, for layer 1, the percent difference value for block AA′ is calculated from;

$$PD ( A , {A}^{′} ) = {\sum }_{i < j = 1}^{4} \frac{\vert {L}_{i} - {L}_{j} \vert}{6 \times 256}$$

Where Lᵢ is the luminosity value for pixel i and the summation is over i<j for j=1 to 4 so there are 6 terms in the sum and the luminosity has a scale range of 256.
(iii) The absolute luminosity for block AA′ is calculated from;

$$AL ( A , {A}^{′} ) = {\sum }_{i = 1}^{4} \frac{{L}_{i}}{4}$$

Where the sum is over i=1 to 4.
(iv) The PD and AL values are calculated for all of the 2×2 blocks in level 1 and the UI value for the layer 1 is then calculated from;

UI₁=(SD of all of the blocks'PD(m,n))×(Average of all the blocks'PD(m,n))×(SD of all of the blocks'AL(m,n)).

Where SD refers to standard deviation.

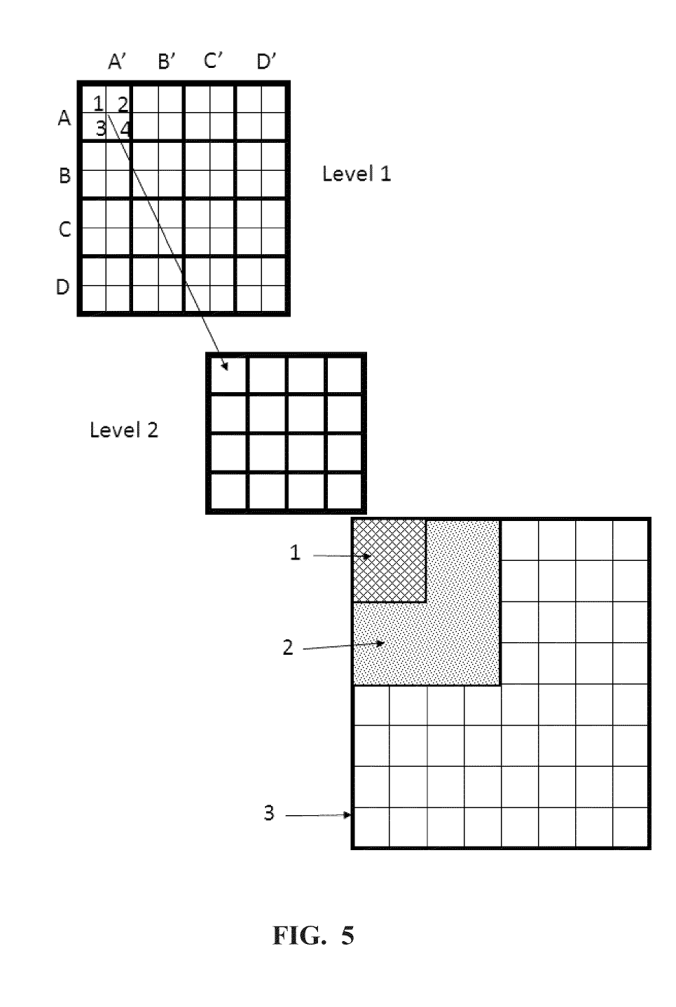

FIG. 5 shows how the block AA′ in level 1 now becomes an element of a single block in level 2. The process steps above are then repeated for layers 2 up to the largest layer number that the image can support where the layer definitions are seen in FIG. 5. For example, layer 1 consists of blocks that consist of the 2×2 pixel squares. Layer 2 consists of four blocks (2×2) where each block consists not of pixel squares but the 2×2 pixel blocks from layer 1. Layer 3 consists of the four blocks where each block consists of the 4×4 pixel blocks from layer 2, and so on until the image cannot accommodate any more levels.

The uniformity index (UI) is then defined as the average UI over all of the layers in the image. i.e.

$$UI = \frac{1}{N} {\sum }_{i = 1}^{N} {UI}_{i}$$

Where the sum is over level numbers and N is the total number of layers in the image.

A lower uniformity index (UI) indicates a more uniform distribution of fibers.

### Measurement of Fiber Orientation

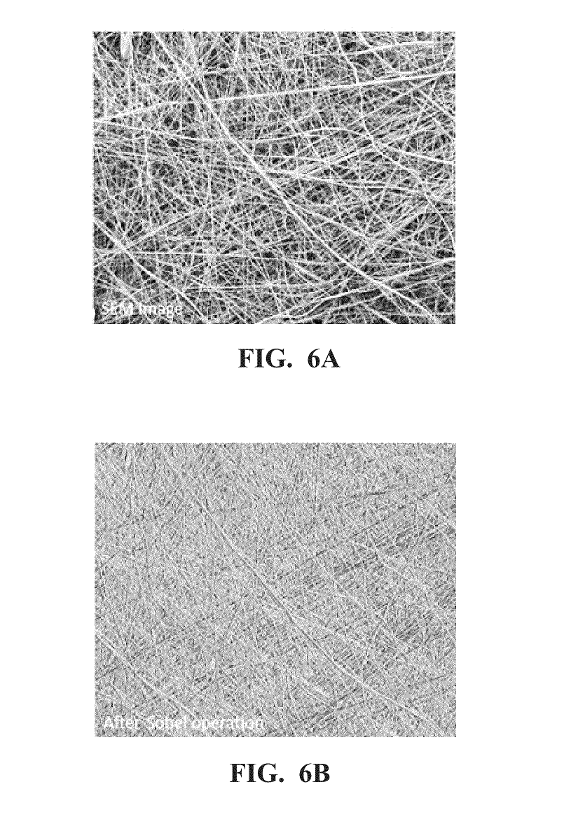

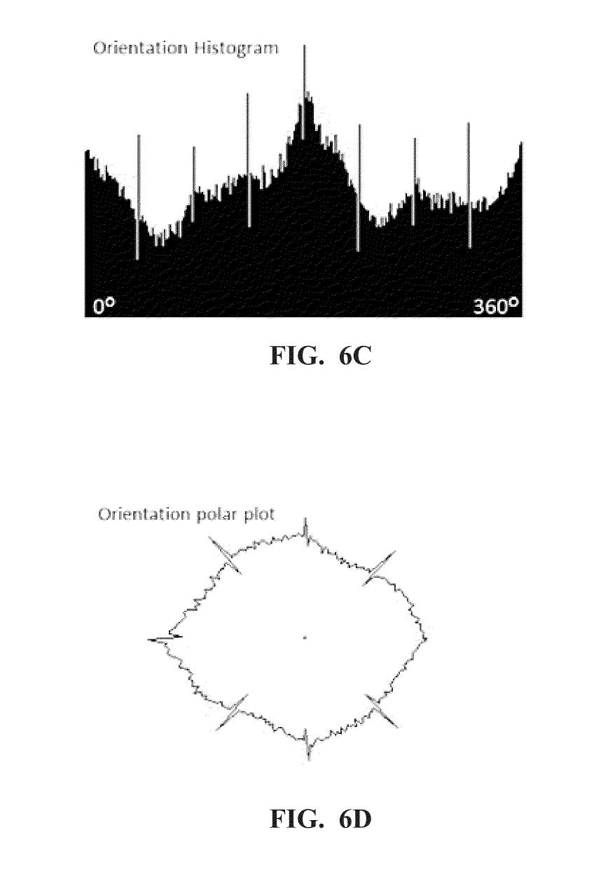

FIGS. 6A-D are an illustration of the steps for the fiber orientation measurement. FIG. 6A is an SEM showing the random distribution of fibers in a web. The Sobel operator in image process calculates the gradient of the image intensity at each point, giving the direction of the largest possible increase from light to dark and the rate of change in that direction. The result therefore shows how “abruptly” or “smoothly” the image changes at that point and therefore how likely it is that that part of the image represents an edge, as well as how that edge is likely to be oriented. In practice, the magnitude (likelihood of an edge) calculation is more reliable and easier to interpret than the direction calculation.

The Sobel operator uses two 3×3 kernels which are convolved with the original image to calculate approximations of the derivatives—one for horizontal changes, and one for vertical. If we define A as the source image, and Gₓ and G_{y} are two images which at each point contain the horizontal and vertical derivative approximations, the computations are as follows:

$${G}_{x} = [ \begin{matrix}- 1 & 0 & + 1 \\ - 2 & 0 & + 2 \\ - 1 & 0 & + 1\end{matrix} ] * A$$

$$and$$

$${G}_{y} = [ \begin{matrix}- 1 & - 2 & - 1 \\ 0 & 0 & 0 \\ + 1 & + 2 & + 1\end{matrix} ] * A$$

where * here denotes the 2-dimensional convolution operation.

Since the Sobel kernels can be decomposed as the products of an averaging and a differentiation kernel, they compute the gradient with smoothing. For example, Gₓ can be written as

$$[ \begin{matrix}- 1 & 0 & + 1 \\ - 2 & 0 & + 2 \\ - 1 & 0 & + 1\end{matrix} ] = [ \begin{matrix}1 \\ 2 \\ 1\end{matrix} ] [ \begin{matrix}- 1 & 0 & 1\end{matrix} ]$$

The x-coordinate is defined here as increasing in the “right”-direction, and the y-coordinate is defined as increasing in the “down”-direction. At each point in the image, the resulting gradient approximations can be combined to give the gradient magnitude, using:

G=\sqrt{Gₓ²+G_{y}²}
Using this information, we can also calculate the gradient's direction:

θ=tan⁻¹(G_{y},Gₓ)

where, for example, θ is 0 for a MD direction.

The fiber orientation is measured from the SEM images with ×250 magnification (see, for example, FIG. 6B), and the distribution can be plotted as orientation histogram (see, for example, FIG. 6C) or a polar plot (see, for example, FIG. 6D). A circle curve on polar plot is for the perfectly random distributed fibers. The parameter “fiber orientation index” is calculated by

$$\begin{matrix}{θ}_{index} = profile in MD / profile in TD \\ = \frac{1}{N} {\sum }_{i = 1}^{N} {\sum }_{θ = 0}^{360} \frac{sin θ \times {I}_{i}}{cos θ \times {I}_{i}}\end{matrix}$$

Where profile in MD is the intensity profile in MD direction on orientation plot, and Where profile in TD is the intensity profile in TD direction on orientation plot.

### Measurement of Fiber Curl Index

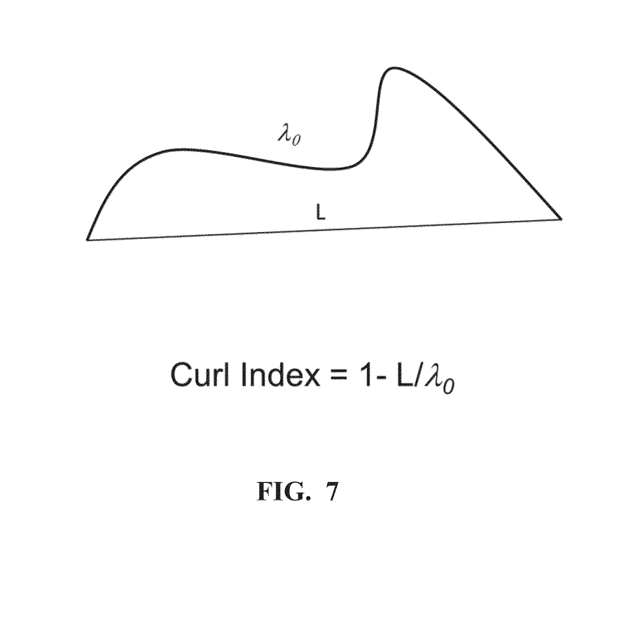

In order to characterize the fiber straightness, the Curl Index as illustrated in FIG. 7 was used in the present invention. The definition of Curl Index is 1 minus the ratio of the true contour length λ₀ of the fiber divided by the projected length L.

$${Curl}_{index} = 1 - \frac{1}{N} {\sum }_{i = 1}^{N} {L}_{i} / ( {λ}_{0} ) i$$

The Curl Index is measured from the SEM images with ×1,000 magnification for each individual fiber. A Curl Index of 1 indicates that no curl is present.

### Measurement of Pore Size and Pore Size Distribution

Minimum Pore Size was measured as described above according to ASTM Designation E 1294-89, “Standard Test Method for Pore Size Characteristics of Membrane Filters Using Automated Liquid Porosimeter”. Individual samples of different size (8, 20 or 30 mm diameter) were wetted with low surface tension fluid (1,1,2,3,3,3-hexafluoropropene, or “Galwick,” having a surface tension of 16 dyne/cm). Each sample was placed in a holder, and a differential pressure of air was applied and the fluid removed from the sample. The minimum pore size is the last pore to open after the compressed pressure is applied to the sample sheet, and is calculated using software supplied from the vendor.

Mean Flow Pore Size was measured according to ASTM Designation E 1294-89, “Standard Test Method for Pore Size Characteristics of Membrane Filters Using Automated Liquid Porosimeter.” Individual samples of different size (8, 20 or 30 mm diameter) were wetted with the low surface tension fluid as described above and placed in a holder, and a differential pressure of air was applied and the fluid removed from the sample. The differential pressure at which wet flow is equal to one-half the dry flow (flow without wetting solvent) is used to calculate the mean flow pore size using supplied software.

Bubble Point was measured according to ASTM Designation F316, “Standard Test Methods for Pore Size Characteristics of Membrane Filters by Bubble Point and Mean Flow Pore Test.” Individual samples (8, 20 or 30 mm diameter) were wetted with the low surface tension fluid as described above. After placing the sample in the holder, differential pressure (air) is applied and the fluid was removed from the sample. The bubble point was the first open pore after the compressed air pressure is applied to the sample sheet and is calculated using vendor supplied software.

Uniformity Index (UI) of the pore size is defined as the ratio of the difference in bubble point diameter and the minimum pore size to the difference in the bubble point and mean flow pore. The closer this ratio is to the value of 2, and then the pore distribution is a Gaussian distribution. If the Uniformity Index is much larger than 2, the nonwoven structure is dominated by pores whose diameters are much bigger than the mean flow pore. If the Uniformity Index is much lower than 2, then the pore structure is dominated by pores which have pore diameters lower than the mean flow pore diameter. There will still be a significant number of large pores in the tail end of the distribution.

$${UI}_{pore} = \frac{BP - Min}{BP - MFP}$$

Since the uniformity index for of the media of the present invention and comparative examples are in the range of 1.0 to 2.0. Additional characterization has to be used for distinguishing the differences between the examples of the invention and the comparative examples.

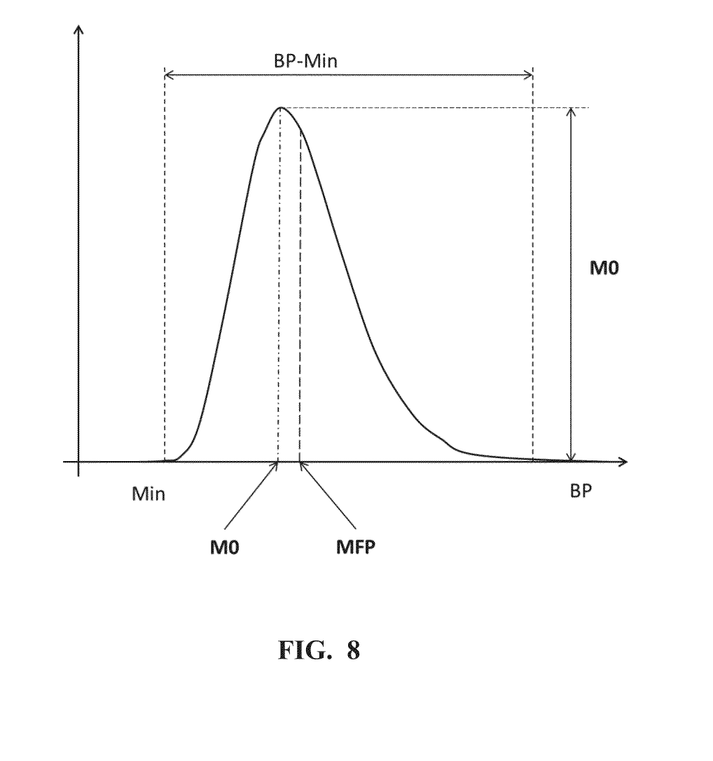

FIG. 8 is a schematic representation of pore size distribution for a web. Two parameters are defined as follows.

The Center Index,

CI_{PMI}=|MFP−M0|

is the mean flow pore size minus the mode of the pore size. The smaller CI_{PMI}, the smaller the departure of MFP from M0;

The Distribution Width Index (DWI_{PMI}) is given by W/H_{M0}, and is the ratio of the 99% width of the pore size distribution (W≅BP−Min) to the height at the mode M0, of the pore size;

$${DWI}_{PMI} = \frac{BP - Min}{{H}_{M 0}}$$

Therefore, the smaller DWI_{PMI}, the narrower the distribution.

### Measurement of Web Strength

Tensile strength and elongation of nanoweb samples were measured using an INSTRON tensile tester model 1122, according to ASTM D5035-11, “Standard Test Method for Breaking Force and Elongation of Textile Fabrics (Strip Method)” with modified sample dimensions and strain rate. Gauge length of each sample was 2 inches (5.08 cm) with 0.5 inch (1.27 cm) width. Crosshead speed was 1 inch (2.54 cm)/min (a constant strain rate of 50% min⁻¹). Samples are tested in the “Machine Direction” (MD) as well as in the “Transverse Direction” (TD). A minimum of 3 specimens are tested to obtain the mean value for tensile strength or elongation.

Hereinafter the present invention will be described in more detail in the following examples. A melt spinning process and apparatus for forming a nanofiber of the invention as disclosed in U.S. Pat. No. 8,277,711 was used to produce the melt spun nanowebs of the invention as embodied in the examples below.

### Example 1

### Centrifugal Melt-Spun Polypropylene (PP) 650Y Nanoweb

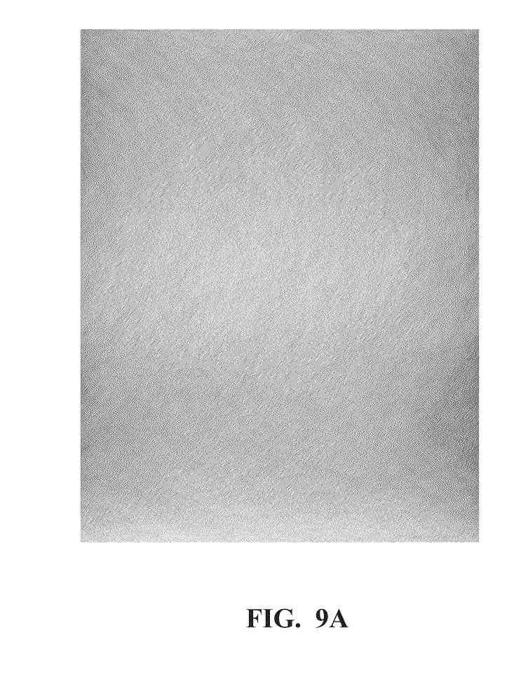

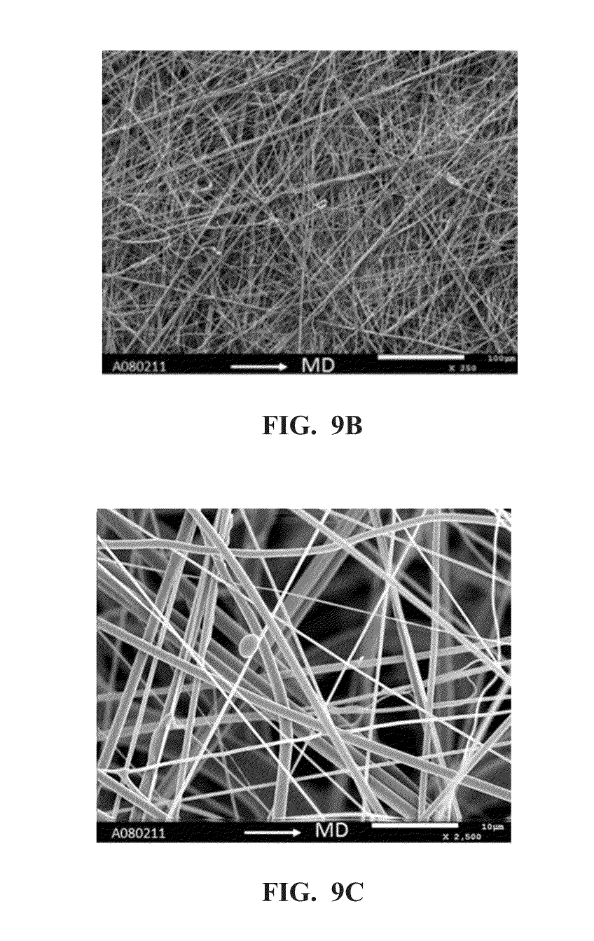

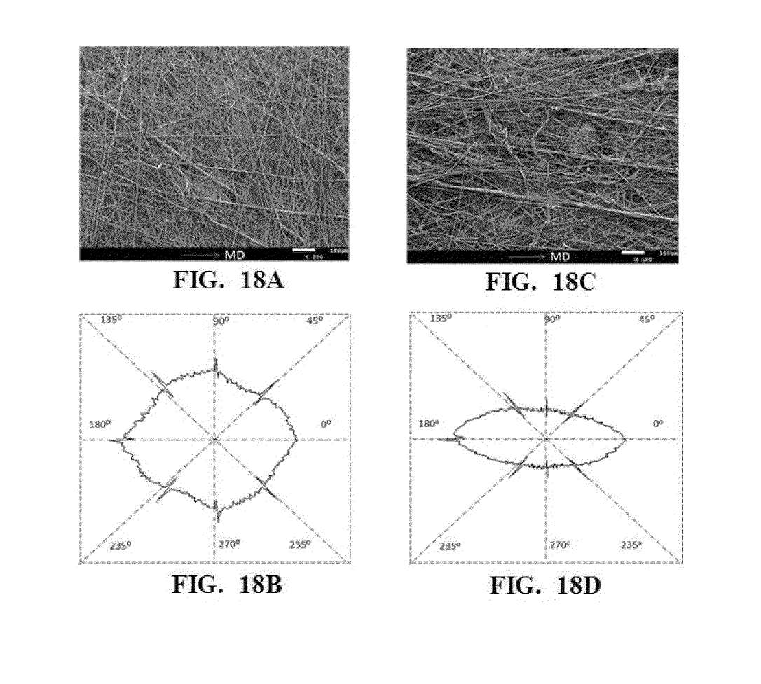

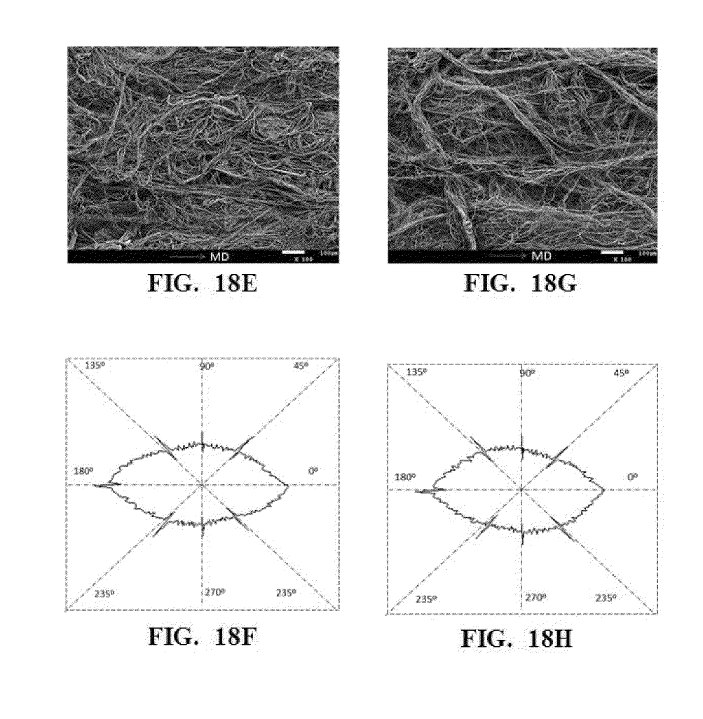

A polypropylene (PP) nanoweb consisting of continuous fibers was made using centrifugal melt spin process of U.S. Pat. No. 8,277,711 with a 150 mm diameter spin disk with reservoir and disk inner edge. The PP nanoweb was laid on a belt collector using the process of U.S. Patent Application Publication No. 2009/0160099. The PP resin used in this example is a low molecular weight (Mw) polypropylene (PP) homopolymer, Metocene MF650Y from LyondellBasell. It had a Mw=68.000 g/mol, and melt flow rate=1800 g/10 min (230° C./2.16 kg). A PRISM extruder with a gear pump was used to deliver the polymer melt to the rotating spin disk through the supply tube. The temperature of the spinning melt from the melt supply tube was set to 240° C. The disk heating air was set at 260° C. The stretching zone heating air was set at 150° C. The shaping air was set at 30° C. The rotation speed of the spin disk was set to a constant 10,000 rpm. FIG. 9A shows the web image and FIGS. 9B-C show the SEM image of a web with a laydown distance of 130 mm and with dual high voltage charging of +50 kV and 0.6 mA on collector belt, −12 kV and 0.6 mA on corona ring, and a center air was applied through the hollow rotating shaft and an anti-swirling hub. The web uniformity index was UI=4.03384 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=430 nm and median=381 nm. FIG. 18A shows the SEM image used to prepare the orientation plot in FIG. 18B. The fiber orientation preference is neither in the TD nor the MD direction.

### Example 2

### Centrifugal Melt-Spun Polypropylene (PP) 650W Nanoweb

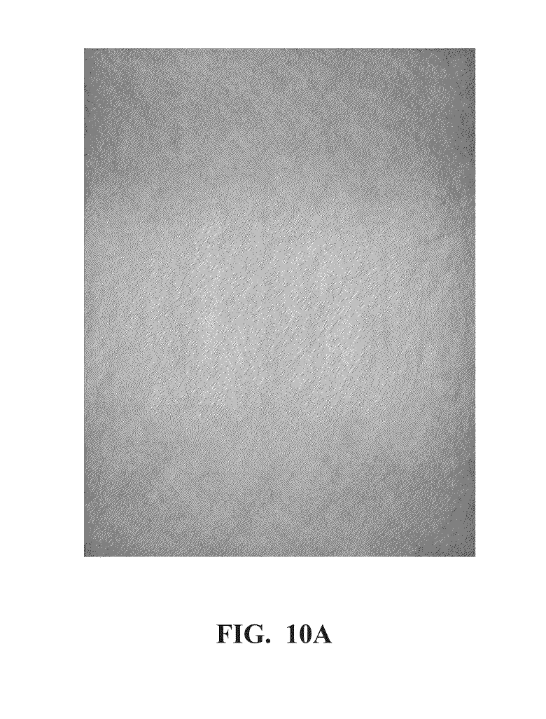

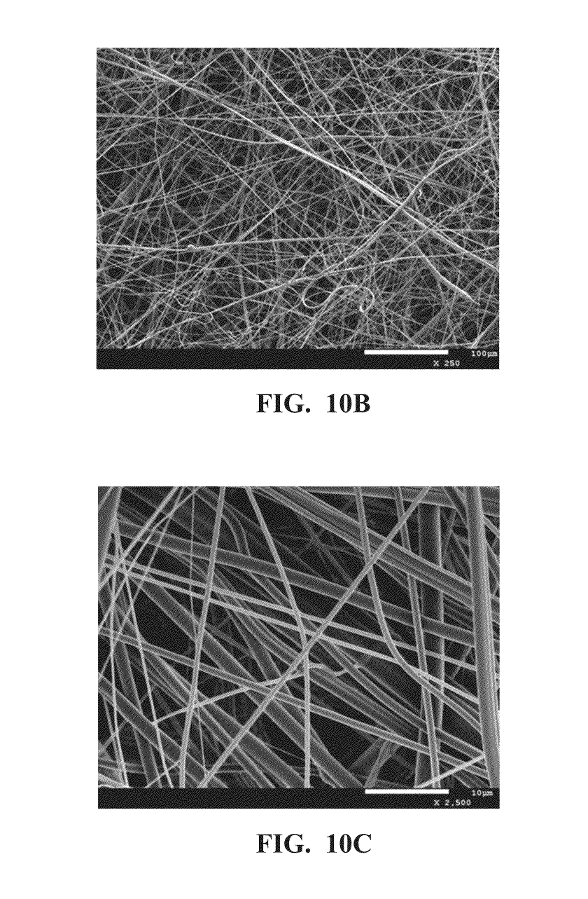

A polypropylene (PP) nanoweb consisting of continuous fibers was made using centrifugal melt spin process of U.S. Pat. No. 8,277,711 with a 150 mm diameter spin disk with reservoir and disk inner edge. The PP nanoweb was laid on a belt collector using the process of U.S. Patent Application Publication No. 2009/0160099. The PP resin used in this example is polypropylene (PP) homopolymer, Metocene MF650W from LyondellBasell. It had a Mw=168.000 g/mol, and melt flow rate=500 g/10 min (230° C./2.16 kg). A PRISM extruder with a gear pump was used to deliver the polymer melt to the rotating spin disk through the supply tube. The temperature of the spinning melt from the melt supply tube was set to 240° C. The disk heating air was set at 260° C. The stretching zone heating air was set at 150° C. The shaping air was set at 100° C. The rotation speed of the spin disk was set to a constant 10,000 rpm. FIG. 10A shows the web image and FIGS. 10B-C show the SEM image of a web with a laydown distance of 130 mm and with dual high voltage charging of +50 kV and 0.6 mA on collector belt, −12 kV and 0.6 mA on corona ring, and a center air was applied through the hollow rotating shaft and an anti-swirling hub. The web uniformity index was UI=4.67014 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=430 nm and median=381 nm.

### Example 3

### Centrifugal Melt-Spun Polypropylene (PP) Malex Nanoweb

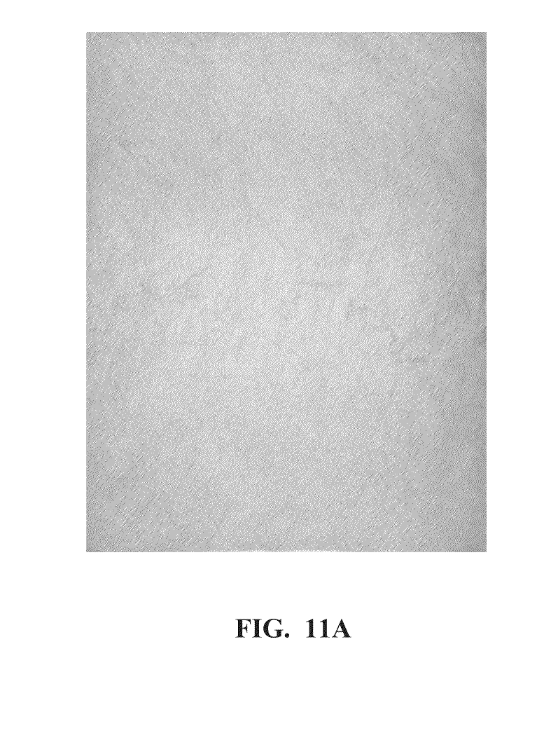

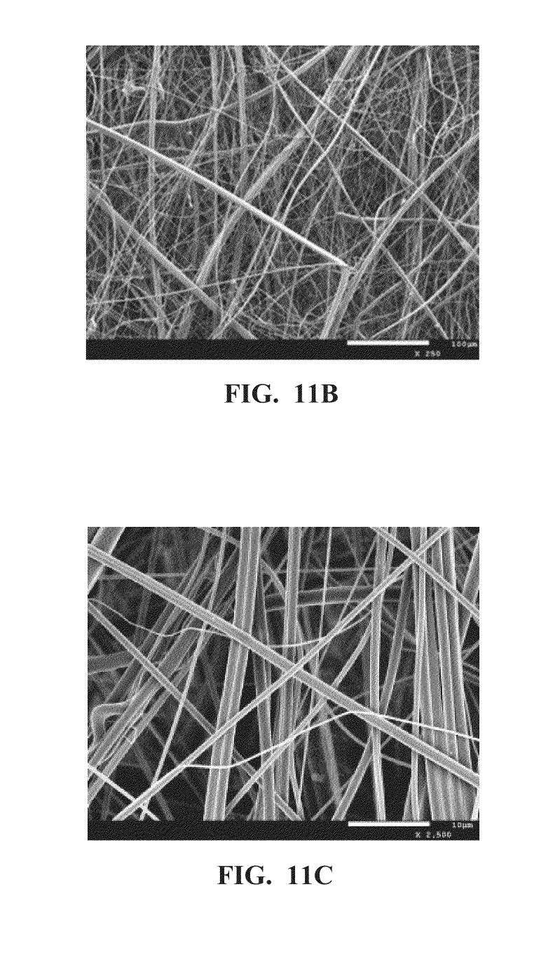

A polypropylene (PP) nanoweb consisting of continuous fibers was made using centrifugal melt spin process of U.S. Pat. No. 8,277,711 with a 150 mm diameter spin disk with reservoir and disk inner edge. The PP nanoweb was laid on a belt collector using the process of U.S. Patent Application Publication No. 20090160099. The PP resin used in this example is a polypropylene (PP) 50%/50% blend of a high Mw PP and a low Mw PP. The high Mw PP was Marlex HGX-350 from Phillips Sumika. It had a Mw=292,079 g/mol, and melt flow rate=35 g/10 min (230° C./2.16 kg). The low Mw PP is Metocene MF650Y used in example 2. A PRISM extruder with a gear pump was used to deliver the polymer melt to the rotating spin disk through the supply tube. The temperature of the spinning melt from the melt supply tube was set to 240° C. The disk heating air was set at 280° C. The stretching zone heating air was set at 180° C. The shaping air was set at 30° C. and 15 SCFM. The rotation speed of the spin disk was set to a constant 10,000 rpm. FIG. 11A shows the web image and FIGS. 11B-C show the SEM image of a web with a laydown distance of 130 mm with dual high voltage charging of +50 kV and 0.6 mA on collector belt, −12 kV and 0.6 mA on corona ring, and a center air was applied through the hollow rotating shaft and an anti-swirling hub. The web uniformity index was UI=4.5071 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=640 nm and median=481 nm.

### Example 4

### Centrifugal Melt-Spun Polyethylene Terephthalate (PET) Nanoweb

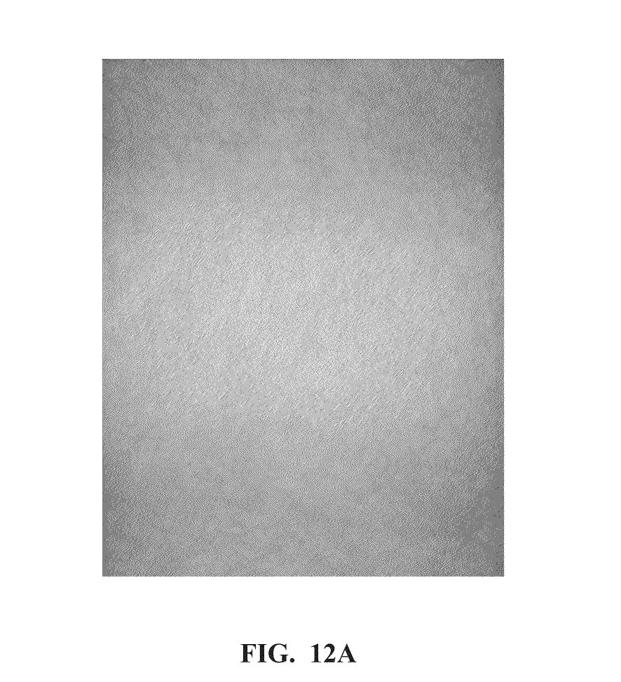

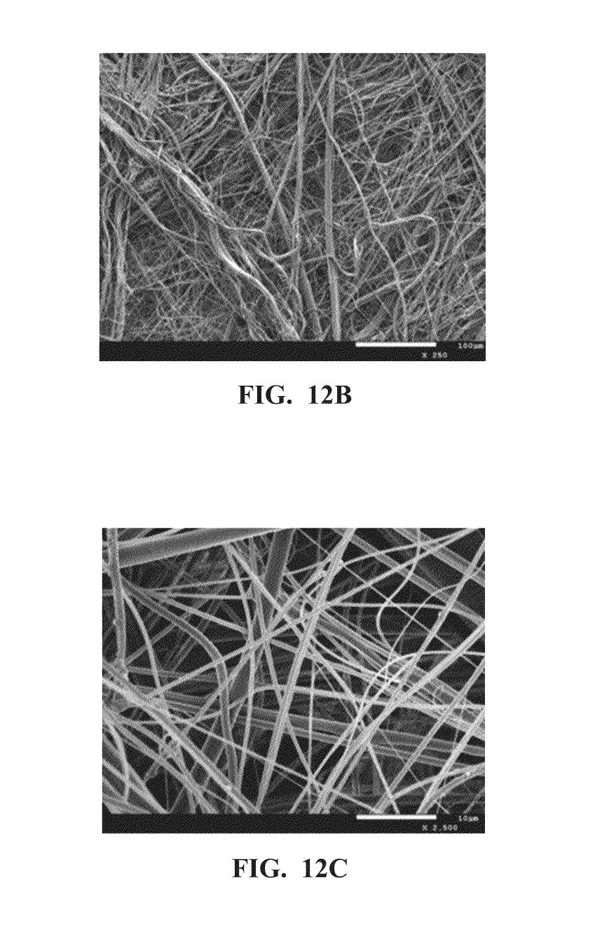

A polyethylene terephthalate (PET) nanoweb consisting of continuous fibers was made using centrifugal melt spin process of U.S. Pat. No. 8,277,711 with a 150 mm diameter spin disk with reservoir and disk inner edge. The PET nanoweb was laid on a belt collector using the process of U.S. Patent Application Publication No. 2009/0160099. The PET resin used in this example was homopolymer, PET F61, from Eastman Chemical. A PRISM extruder with a gear pump was used to deliver the polymer melt to the rotating spin disk through the supply tube. The temperature of the spinning melt from the melt supply tube was set to 260° C. The disk heating air was set at 280° C. The stretching zone heating air was set at 180° C. The shaping air was set at 30° C. The rotation speed of the spin disk was set to a constant 10,000 rpm. The laydown belt was moving at 22.5 cm/min. FIG. 12A shows the web image and FIGS. 12B-C show the SEM image of a web with a laydown distance of 130 mm with a high voltage charging of +50 kV and 0.6 mA on collector belt and a center air was applied through the hollow rotating shaft and an anti-swirling hub. The web uniformity index was UI=4.7113 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=730 nm and median=581 nm.

### Example 5

### Centrifugal Melt-Spun Polypropylene (PP) 650Y Nanoweb

A polypropylene (PP 650Y) nanoweb consisting of continuous fibers was made the same as in Example 1. A spin bowl of 150 mm diameter with induction heating has been used as the spin head. A PRISM extruder with a gear pump with extrusion temperature setting of 200° C. was used to deliver the polymer melt to the rotating spin disk through the supply tube. The temperature of the spinning melt from the melt supply tube was set to 200° C. The induction heating to spin bowl was set to 1.5 kW. The air heater for the bowl shaping air was set at 250° C. with air flow rate of 7.0 SCFM. The air heater for the stretching zone heating air was set at 150° C. with air flow rate of 8.0 SCFM. The center air was set at 30° C. and 2.0 SCFM. The rotation speed of the spin bowl was set to a constant 10,000 rpm. The web laydown distance is 130 mm with dual high voltage charging of +56 kV and 0.27 mA on collector belt, −7.5 kV and 0.39 mA on corona ring.

The web uniformity index was UI=4.0843 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=630 nm and median=571 nm.

### Example 6

### Centrifugal Melt-Spun Polypropylene (PP) 650Y Nanoweb

A polypropylene (PP 650Y) nanoweb consisting of continuous fibers was made the same as in Example 7 with the same extrusion conditions. The induction heating to spin bowl was set to 1.7 kW. The air heater for the bowl shaping air was set at 250° C. with air flow rate of 7.0 SCFM. The air heater for the stretching zone heating air was set at 150° C. with air flow rate of 8.0 SCFM. The center air was set at 50° C. and 2.5 SCFM. The rotation speed of the spin bowl was set to a constant 10,000 rpm. The web laydown distance is 130 mm with dual high voltage charging of +56 kV and 0.27 mA on collector belt, −7.5 kV and 0.39 mA on corona ring.

The web uniformity index was UI=4.2843 on a web sample size of 300 mm by 200 mm at 10.2 megapixel of 3872 by 2592 pixels. The fiber size was measured from an image using scanning electron microscopy (SEM) and the fibers were determined to have an average fiber diameter of about mean=656 nm and median=590 nm.

### Example 7

### Centrifugal Melt-Spun Polypropylene (PP) 650Y Nanoweb

A polypropylene (PP 650Y) nanoweb consisting of continuous fibers was made the same as in Example 6 with the same extrusion conditions. The web uniformity index was UI=4.4379 on a web sample size of 300 mm by 200 mm at 10.2 megapixel of 3872 by 2592 pixels. The fiber size was measured from an image using scanning electron microscopy (SEM) and the fibers were determined to have an average fiber diameter of about mean=689 nm and median=610 nm.

### Comparative Example 1

### Centrifugal Melt-Spun Polypropylene (PP) 650Y Nanoweb

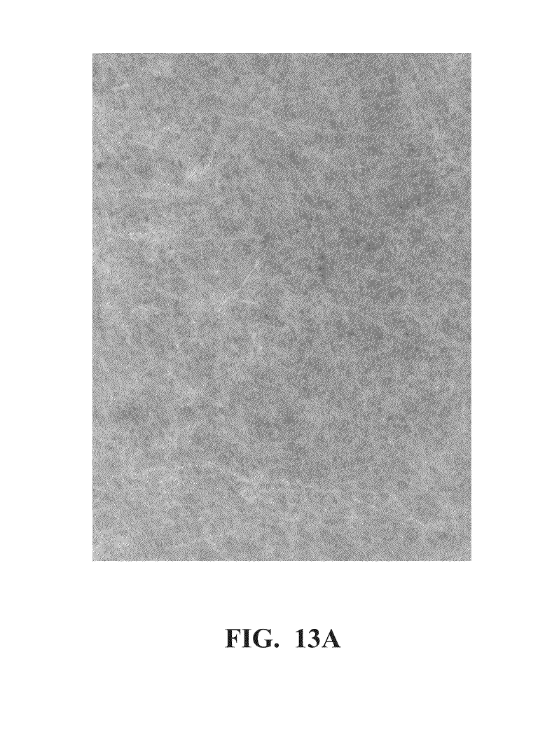

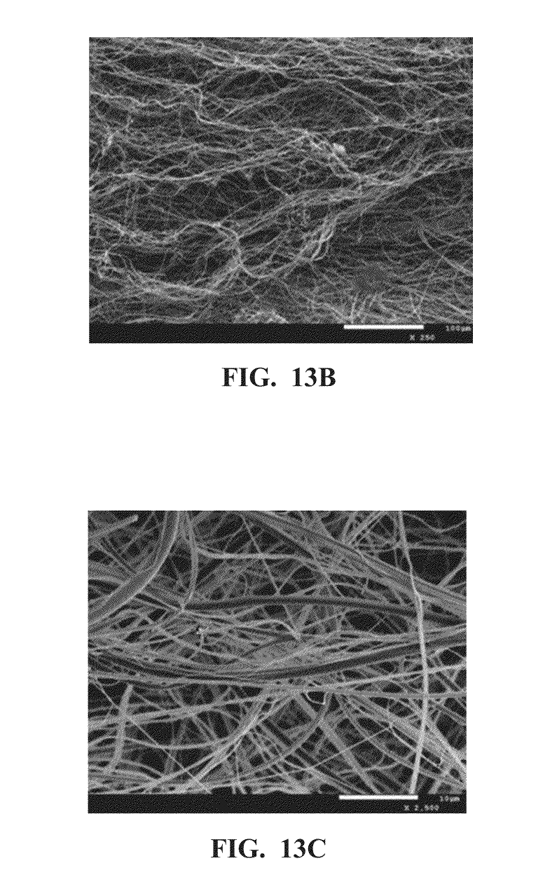

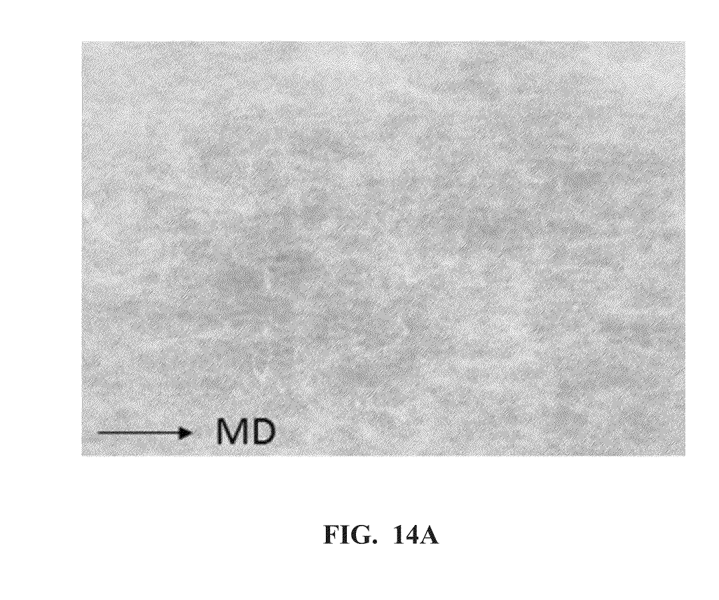

A polypropylene (PP 650Y) nanoweb consisting of continuous fibers was made same as in Example 1 with the same extrusion and spinning conditions but a different web laydown condition. A web was collected using a vertical tubular belt surrounding the spin disk with no applied charging and no air management. FIG. 13A shows the web image and FIGS. 13B-C show the SEM images.

The web uniformity index was UI=5.658 on a web sample size of 300 mm by 200 mm at 10.2 megapixel of 3872 by 2592 pixels. The fiber size was measured from an image using scanning electron microscopy (SEM) and the fibers were determined to have an average fiber diameter of about mean=563 nm and median=520 nm.

### Comparative Example 2

### Hot Gas-Assisted Melt Electro-Spun Polypropylene (PP) 650Y

Comparative Example 2 was a polypropylene (PP 650Y) nanoweb consisting of continuous fibers made by using a gas assisted melt electrospinning apparatus (Eduard Zhmayev, Daehwan Cho, Yong Lak Joo, Nanofibers from Gas-Assisted Polymer Melt Electrospinning, Polymer 51 (2010) 4140-4144.)

The PP nanofiber was spun in a single orifice heated at 220° C. apparatus comprising a 22 gauge blunt syringe needle, in a concentric forwarding air jet with heated about 220° C. and air flow velocity of 12 m/s. A high voltage of 30 kV was applied to the spin pack and the spin orifice. The throughput of PP melt is about 0.01 g/min. The fibers were laid on a collector with a distance to spin orifice of 300 mm. The fiber size was measured from an image using scanning electron microscopy (SEM) and the fibers were determined to have a diameter range of from 200 nm to 1200 nm.

### Comparative Example 3

### Melt-Blown Polypropylene (PP) Nanoweb

Comparative Example 5 was made by using the melt blown process of U.S. Patent Application Publication No. 2008/0023888. A low molecular weight polypropylene resin was used (GPH1400M with Melt Flow Rate (MFR) of 2600 from Bassell.) A nanoweb of 5.2 gsm was laid on polyester nonwoven scrim.

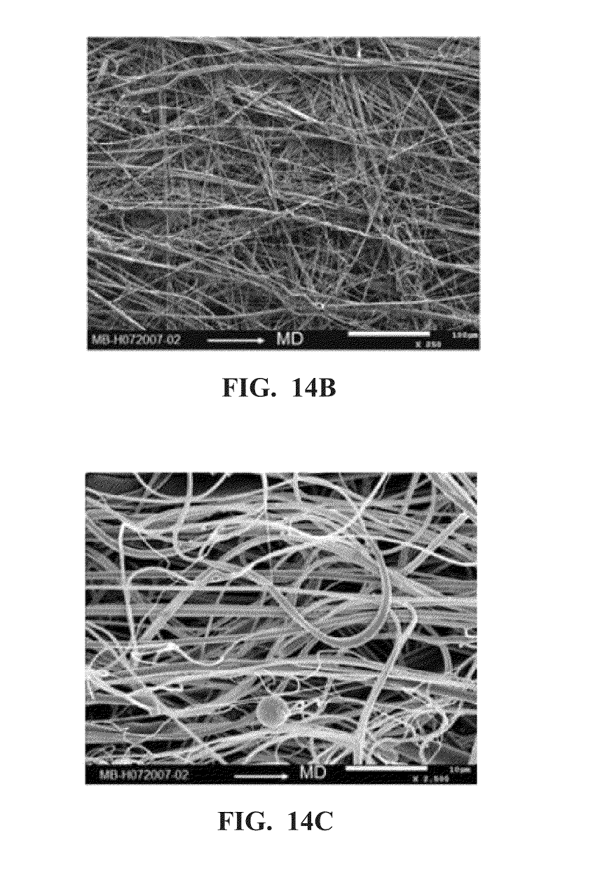

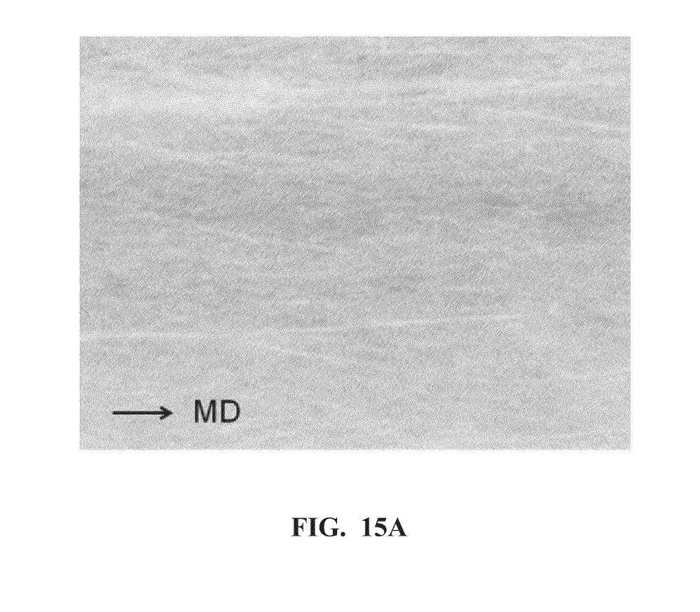

FIG. 14A shows the web image and FIGS. 14B-C show the SEM images. The web uniformity index was UI=19.72697 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=532 nm and median=514 nm. FIG. 18C shows the SEM image used to prepare the orientation plot in FIG. 18D. The fiber orientation preference is in the transverse direction (TD).

### Comparative Example 4

### Melt-Blown Polypropylene (PP) Nanoweb

Comparative Example 4 was made by using a conventional melt blowing process.

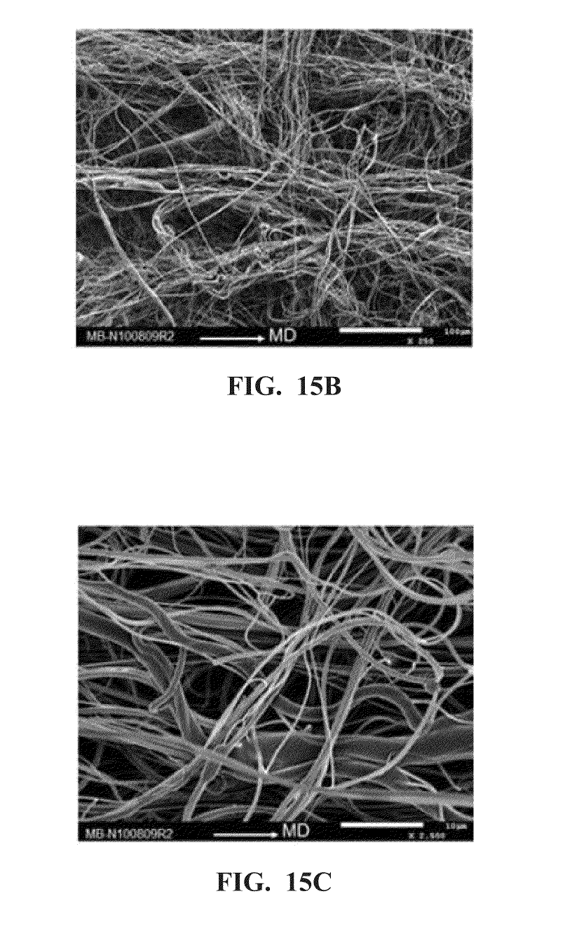

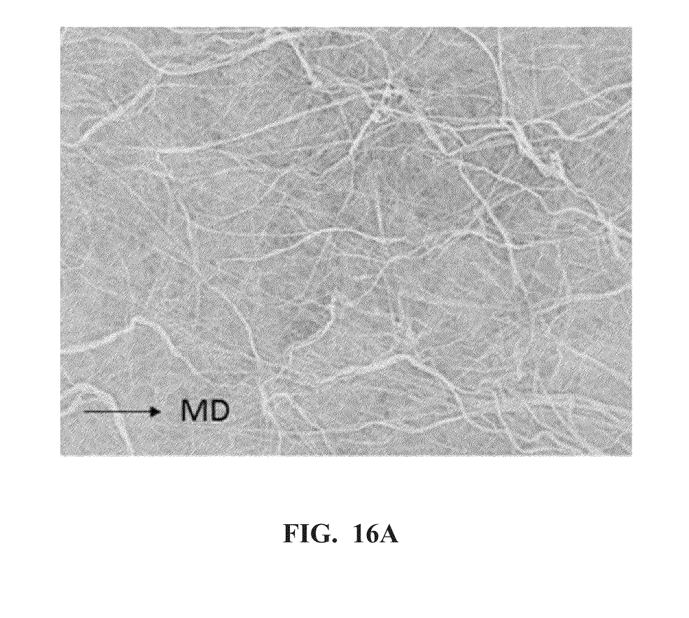

FIG. 15A shows the web image and FIGS. 15B-C show the SEM images. The web uniformity index was UI=27.1465 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=483 nm and median=456 nm. FIG. 18E shows the SEM image used to prepare the orientation plot in FIG. 18F. The fiber orientation preference is in the transverse direction (TD).

### Comparative Example 5

### Melt-Blown Polypropylene (Pp) Nanoweb

Comparative Example 5 was a 150 gsm melt blown PP handsheet of nanofiber product. (Milliken & Company, Spartanburg, S.C.)

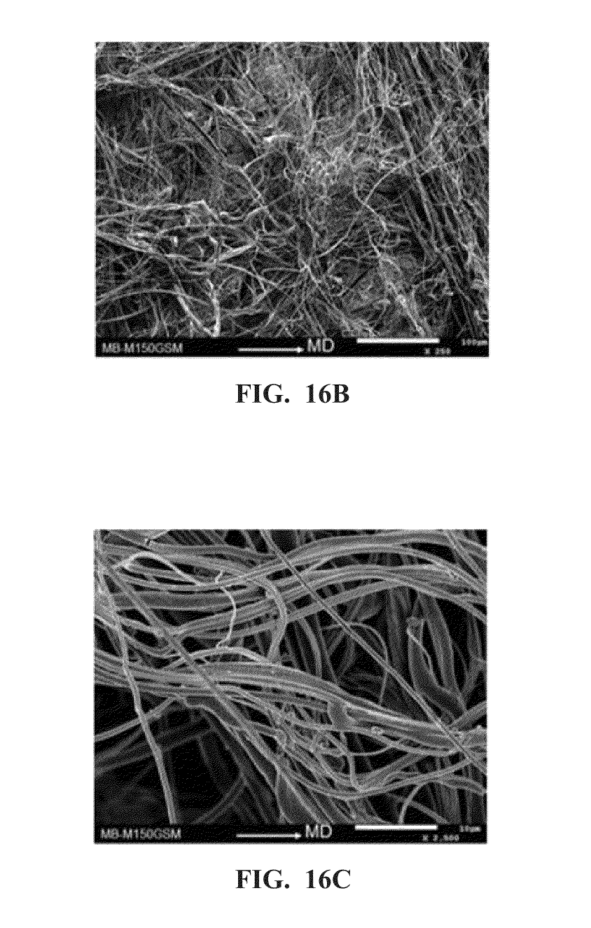

FIG. 16A shows the web image and FIGS. 16B-C show the SEM images. The web uniformity index was UI=107.0765 on a web sample size of 300 mm by 200 mm at 10.2 megapixel of 3872 by 2592 pixels. The fiber size was measured from an image using scanning electron microscopy (SEM) and the fibers were determined to have an average fiber diameter of about mean=538 nm and median=521 nm. FIG. 18G shows the SEM image used to prepare the orientation plot in FIG. 18H. The fiber orientation preference is in the transverse direction (TD).

### Comparative Example 6

### Film Fibrillated Polypropylene (PP) Nanoweb

Comparative Example 6 was a 125.7 gsm polypropylene (PP 650Y) nanoweb consisting of continuous fibers was made by using the melt blown film fibrillation process of U.S. Pat. No. 4,536,361. A low molecular weight polypropylene resin was used (PP GPH1400M with Melt Flow Rate (MFR) of 2600 from Basell).

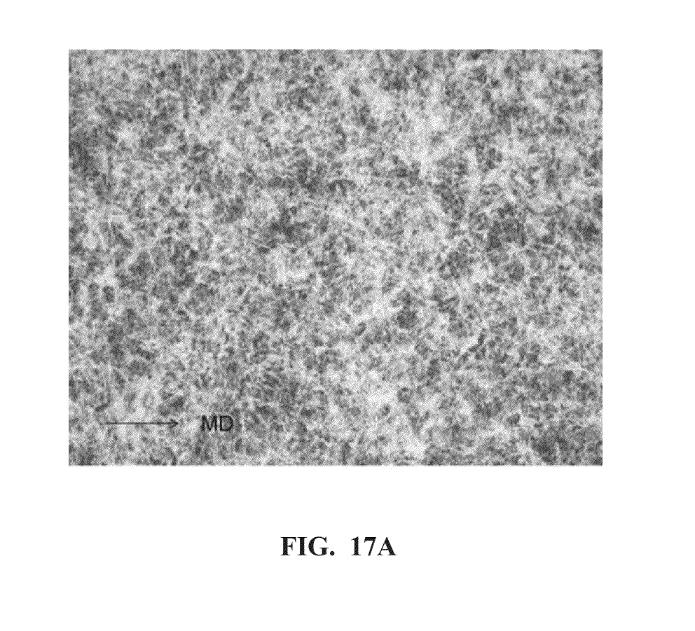

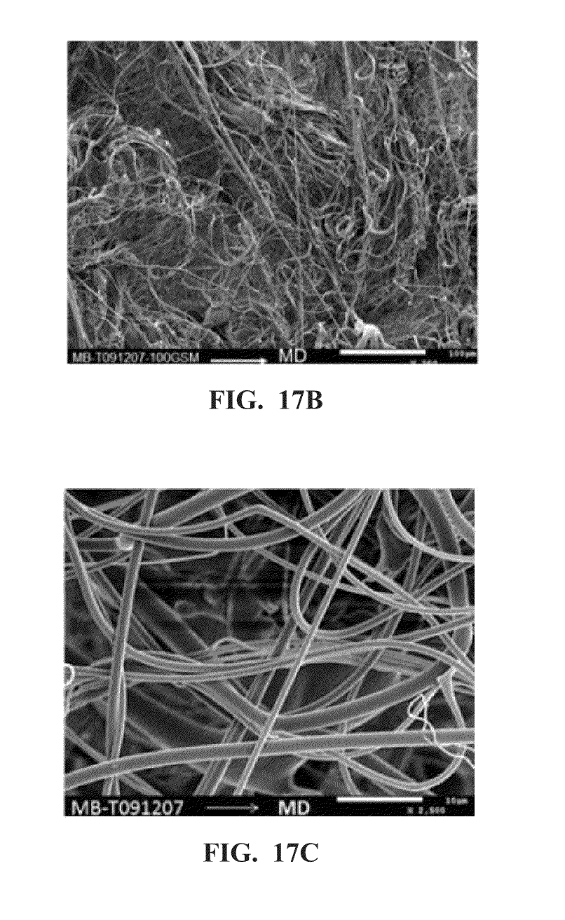

FIG. 17A shows the web image and FIGS. 17B-C show the SEM images. The web uniformity index was very high as UI=65.8183 on a web sample size of 300 mm by 200 mm at 10.2 megapixel of 3872 by 2592 pixels. The fiber size was measured from an image using scanning electron microscopy (SEM) and the fibers were determined to have an average fiber diameter of mean=689 nm and median=610 nm.

Table 1 summarizes the uniformity index and curl index data for the samples presented here.

TABLE 1
Uniformity, Curl and Orientation Data

| | | | Mean | |
|---|---|---|---|---|
| | | Uniformity | Curl | Orientation |
| Sample | Description | Index | Index | Index |
| Example 1 | PP centrifugal melt | 4.03 | 0.001 | 1.046 |
| Example 2 | PP centrifugal melt | 4.67 | 0.027 | 1.032 |
| Example 3 | PP centrifugal melt | 4.507 | 0.016 | 0.985 |
| Example 4 | PET centrifugal melt | 4.711 | 0.029 | 1.003 |
| Example 5 | PP centrifugal melt | 4.084 | 0.031 | 1.057 |
| Example 6 | PP centrifugal melt | 4.284 | 0.032 | 1.089 |
| Example 7 | PP centrifugal melt | 4.438 | 0.067 | 0.892 |
| Comparative | PP centrifugal melt | 5.658 | 0.084 | 1.679 |
| Example 1 | | | | |
| Comparative | PP electrospun melt | N/A | 0.125 | 2.856 |
| Example 2 | | | | |
| Comparative | PP melt blown | 19.72697 | 0.158 | 2.412 |
| Example 3 | | | | |
| Comparative | PP melt blown | 27.1465 | 0.173 | 1.782 |
| Example 4 | | | | |
| Comparative | PP melt blown | 107.0765 | 0.157 | 1.875 |
| Example 5 | | | | |
| Comparative | PP melt blown/split | 65.82 | 0.156 | 1.543 |
| Example 6 | | | | |

N/A = large enough size web sample is not available.

### Tensile Property Measurements

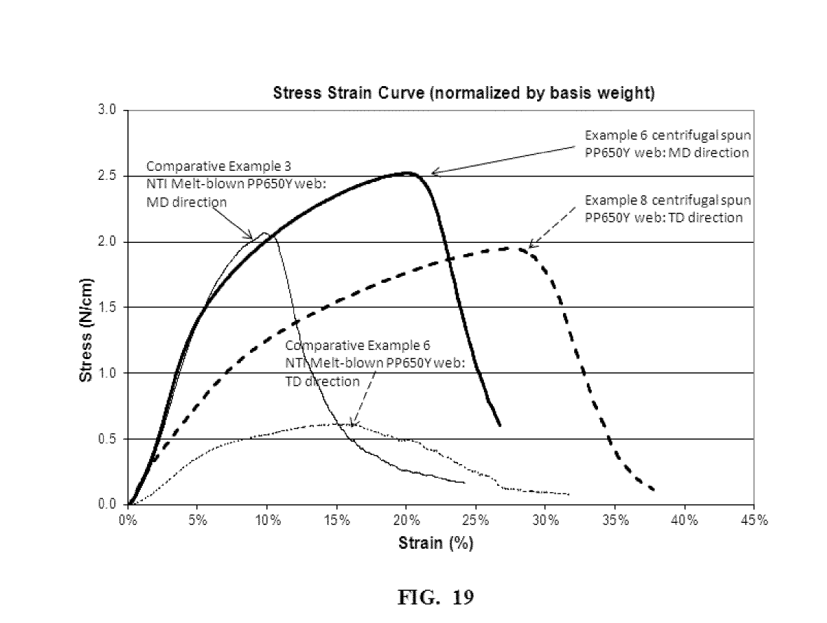

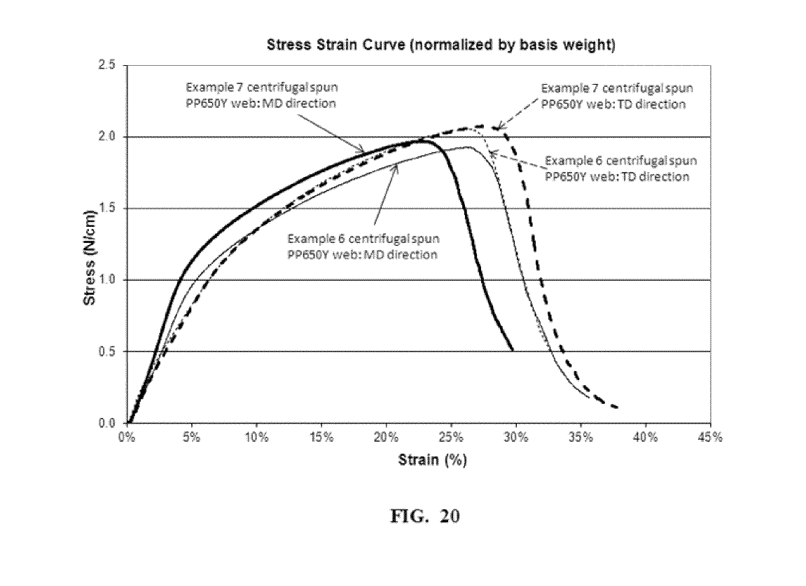

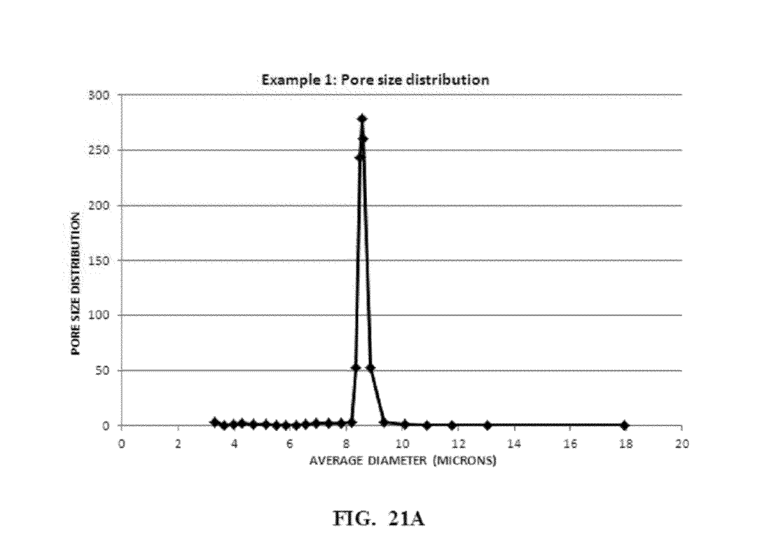

FIG. 19 shows stress-strain curves (normalized by basis weight) of centrifugal spun polypropylene webs compared to melt blown polypropylene webs. FIG. 20 shows stress-strain curves (normalized by basis weight) of centrifugal spun polypropylene webs in the machine direction (MD) and the transverse direction (TD). The examples of the invention have relatively higher web strength. Also, the strength in both the TD and MD directions were closer to each other for the examples of the invention. However, the strength in MD direction was much higher than in TD direction for comparative melt blown samples.

### Pore Size Distribution

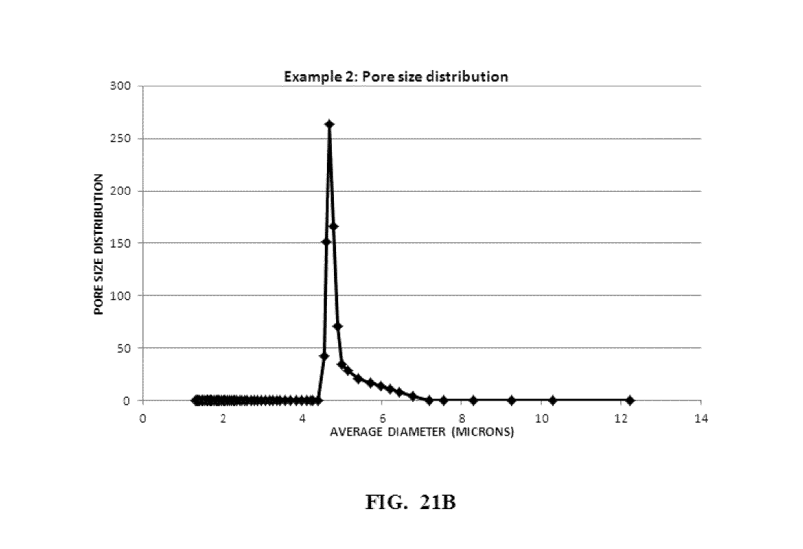

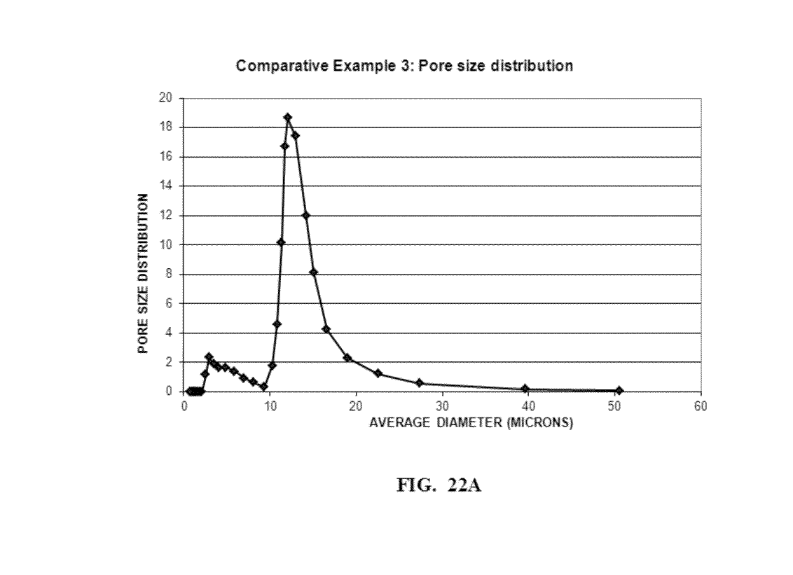

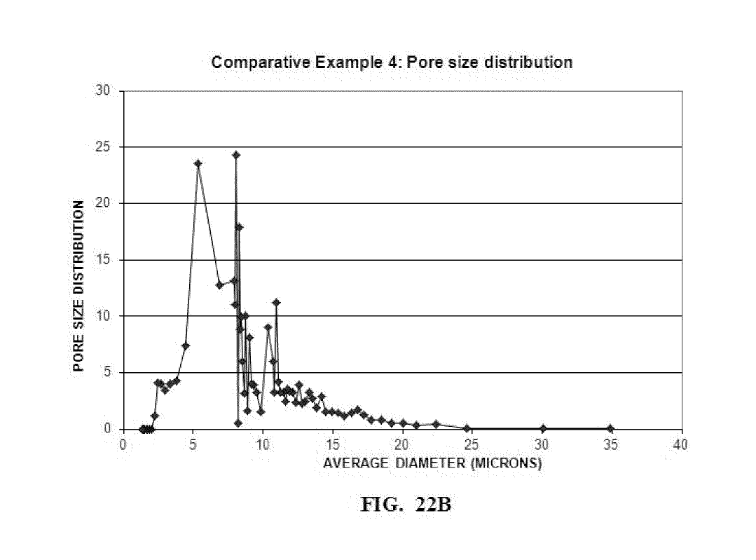

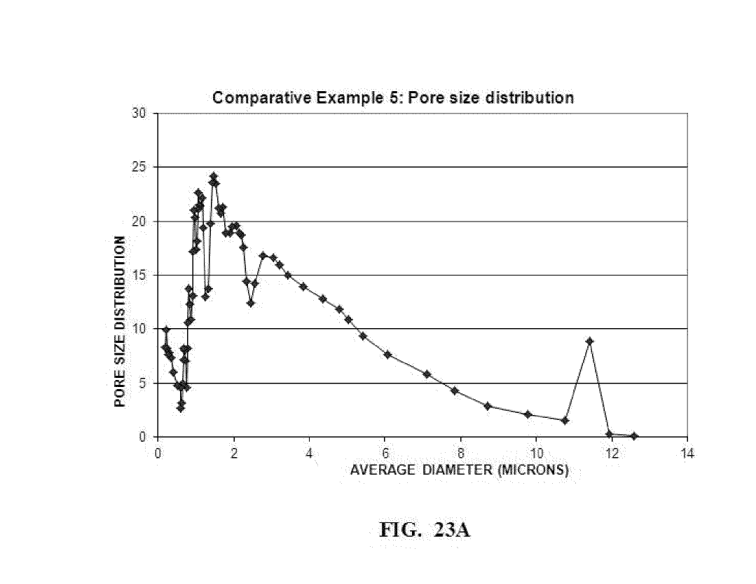

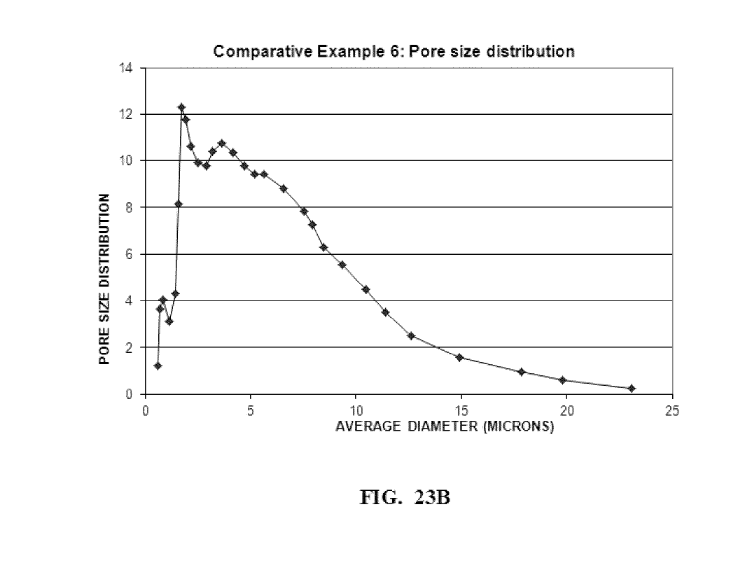

Table 2 shows the PMI measurements on pore size distribution for examples of the invention and comparative examples. FIGS. 21A-B show the very narrow pore size distribution for Example 1 and Example 2 of melt centrifugal spun polypropylene (PP) nanoweb. FIGS. 22A-B show the wider pore size distribution for Comparative Example 3 and Comparative Example 4 of melt blown polypropylene (PP) nanowebs. FIGS. 23A-B show the wider pore size distribution for Comparative Example 5 and Comparative Example 6 of melt blown polypropylene (PP) nanoweb. For examples of the invention, the mean flow pore size minus the mode of the pore size is less than 1.0, and simultaneously the ratio of the 99% width of the pore size distribution (W) to the height (H_{M0}) at the mode M0 of the pore size is less than 0.1.

TABLE 2
Pore Size

| | | | | | | H_{M0} | |
|---|---|---|---|---|---|---|---|
| | BW | M0 (Mode, | MFP | | W (99% pore | (peak | |
| Sample ID | (gsm) | μm) | (μm) | MFP − M0 | range) | height) | W/H_{M0} |
| Example 1 | 5.2 | 8.5456 | 8.5487 | 0.0031 | 1.1445 | 278.62 | 0.0041 |
| Example 2 | 20.68 | 5.1113 | 5.318 | 0.2067 | 3.3988 | 41.31 | 0.0823 |
| Example 3 | 40.5 | 9.19285 | 9.4833 | 0.29045 | 6.7794 | 144.62 | 0.0469 |
| Example 4 | 30.32 | 5.644 | 5.9745 | 0.33053 | 11.8993 | 171.77 | 0.0693 |
| Example 5 | 20.86 | 4.76833 | 5.23587 | 0.46754 | 16.387 | 201.98 | 0.0811 |
| Example 6 | 40.38 | 3.8276 | 4.2316 | 0.404 | 2.3115 | 44.62 | 0.0518 |
| Example 7 | 58.26 | 4.085 | 4.824 | 0.739 | 3.611 | 349.02 | 0.0103 |
| Comparative | 8.5 | 12.0857 | 13.65735 | 1.57165 | 68.3816 | 18.65 | 3.6666 |
| Example 3 | | | | | | | |
| Comparative | 62.5 | 4.331 | 5.9205 | 1.5895 | 19.8185 | 23.54 | 0.8419 |
| Example 4 | | | | | | | |
| Comparative | 150 | 1.5886 | 3.5712 | 1.9826 | 14.2412 | 24.20 | 0.5885 |
| Example 5 | | | | | | | |
| Comparative | 100.98 | 1.7372 | 5.9156 | 4.1784 | 25.408 | 12.32 | 2.0623 |
| Example 6 | | | | | | | |

We claim:

1. A nanoweb comprising polymeric nanofibers in which the polymeric fibers have a mean curl index of less than 0.1 and the nanoweb has a uniformity index of less than 5.0 and wherein the nanoweb is produced by a melt spinning process.

2. The nanoweb of claim 1 wherein the nanoweb has a fiber orientation index of between 0.8 and 1.2.

3. The nanoweb of claim 1 wherein the nanoweb has a mean flow pore size minus the mode of the pore size is less than 1.0 and the ratio of the 99% width of the pore size distribution (W) to the peak height of the pore size at the mode M0 is less than 0.1.

4. The nanoweb of claim 1 wherein the polymeric nanofibers comprise polyolefin or polyester.

5. The nanoweb of claim 1 comprising a multiplicity of continuous polymeric fibers arranged in clusters wherein fibers have an average diameter less than 1,000 nm and wherein the web has a gross morphology corresponding to the following structure;
(i) each fiber is laid in an arc of essentially constant curvature along its length;
(ii) all of the fiber arcs in a given cluster have essentially the same curvature;
(iii) the fiber arcs in a given cluster are co-planar and any given fiber arc in a given cluster lies spaced away from and essentially parallel to the other arcs in said cluster in the plane of the cluster; and
(iv) the centers of curvature of the fiber arcs in a given cluster are co-linear.

6. A nanoweb comprising a plurality of the clusters of claim 5 laid down in a multilayered structure.

7. A nanoweb comprising polymeric nanofibers in which the polymeric fibers have a mean curl index of less than 0.1 and the nanoweb has a uniformity index of less than 5.0 and in which at least some of the fibers comprise a polyolefin.

8. The nanoweb of claim 7 in which all of the fibers comprise a polyolefin.

9. The nanoweb of claim 7 wherein at least some of the fibers consist essentially of a polyolefin.

10. The nanoweb of claim 7 wherein all of the fibers consist essentially of a polyolefin.

11. The nanoweb of claim 7 wherein the polyolefin is selected from the group consisting of polypropylene, polyethylene, polybutene, polymethylpentene, and copolymers thereof.

12. The nanoweb of claim 7 wherein the polyolefin is selected form the group consisting of a copolymer of ethylene with propene, butane, hexane, octane and mixtures thereof.

13. The nanoweb of claim 7 wherein the nanoweb has a fiber orientation index of between 0.8 and 1.2.

14. The nanoweb of claim 7 wherein the nanoweb has a mean flow pore size minus the mode of the pore size is less than 1.0 and the ratio of the 99% width of the pore size distribution (W) to the peak height of the pore size of the mode M0 is less than 0.1.

15. The nanoweb of claim 7 comprising a multiplicity of continuous polymeric fibers arranged in clusters wherein fibers have an average diameter less than 1,000 nm and wherein the web has a gross morphology corresponding to the following structure;
(i) each fiber is laid in an arc of essentially constant curvature along its length;
(ii) all of the fiber arcs in a given cluster have essentially the same curvature;
(iii) the fiber arcs in a given cluster are co-planar and any given fiber arc in a given cluster lies spaced away from and essentially parallel to the other arcs in said cluster in the plane of the cluster; and
(iv) the centers of curvature of the fiber arcs in a given cluster are co-linear.

16. A nanoweb comprising a plurality of the clusters of claim 15 laid down in a multilayered structure.
